(19) United States
(12) Patent Application Publication
(10) Pub. No.: US 2024/0278391 A1
(43) Pub. Date: Aug. 22, 2024

(54) ROTARY TOOLS

(71) Applicant: Kent MORRIS, Scottsdale, AZ (US)

(72) Inventor: Kent MORRIS, Scottsdale, AZ (US)

(21) Appl. No.: 18/583,679

(22) Filed: Feb. 21, 2024

Related U.S. Application Data
(60) Provisional application No. 63/447,336, filed on Feb. 21, 2023.

(51) Int. Cl. B25B 13/50

(52) U.S. Cl. CPC B25B 13/5091

(57) ABSTRACT

A fastener driving tool includes a loop portion defined by a closed contour having a proximal and a distal end. The loop portion defines a longitudinal internal dimension and is interrupted by a gap at a longitudinal distance from the proximal end. A shank is affixed to the proximal end of the loop, with the shank defining a longitudinal axis of rotation. According to preferable embodiments, the longitudinal distance from the proximal end to the gap is less than one-half the longitudinal internal dimension, and the closed contour of the loop may be selected from a set of contours such as an ellipse, an oval, an ovoid, a trapezoid, a trapezoid having stepped sides, and a rectangle.

### CLAIM OF PRIORITY

The present application includes subject matter disclosed in and claims priority to a provisional application entitled “Rotary Tools”, filed Feb. 21, 2023 and assigned Ser. No. 63/447,336, describing an invention made by the present inventor, herein incorporated by reference.

### BACKGROUND OF THE INVENTION

### 1. Field of the Invention

The present invention relates to tools received within a chuck of a rotating drill, impact hammer, or rotary impact drill, for retaining and installing eyebolts and hooks, especially those having a lag screw thread for gripping into wood or similar fibrous materials.

### 2. Description of Related Prior Art

Installing certain types of fasteners may involve ponderous method steps, especially for fasteners having lag bolt threads for following a pilot hole and engaging into fibrous or cancellous materials.

It is therefore a primary object of the present invention to provide a tool able to be retained in a rotary chuck of a power drill or a rotary hammer which temporarily engages with a fastener having a hook or an eye at its end.

Another objective of the invention is to provide a plurality of engagement features in a succession of dimensions so that the fastener being driven may be engaged by the most apt from among the set of features and thus driven most conveniently and efficiently.

These and other objects of the present invention will become apparent to those skilled in the art as the description thereof proceeds.

### SUMMARY OF THE INVENTION

The present invention is directed to a fastener driving tool includes a loop portion defined by a closed contour having a proximal and a distal end. The loop portion defines a longitudinal internal dimension and is interrupted by a gap at a longitudinal distance from the proximal end. A shank is affixed to the proximal end of the loop, with the shank defining a longitudinal axis of rotation. According to preferable embodiments, the longitudinal distance from the proximal end to the gap is less than one-half the longitudinal internal dimension, and the closed contour of the loop may be selected from a set of contours such as an ellipse, an oval, an ovoid, a trapezoid, a trapezoid having stepped sides, and a rectangle.

A drill bit may have a proximal end with a shank adapted to attach to a powered drive mechanism, and a distal end, a center of the shank defining a longitudinal axis as between the proximal and distal ends. The drill bit may include a neck extending distally from the shank, a top shoulder depending from the neck, wherein the top shoulder may include an upper deviation from said longitudinal axis at an angle greater than zero. The drill bit may also include a bottom shoulder depending from said neck. The bottom shoulder may include a lower deviation from the longitudinal axis at an angle greater than zero. The top shoulder and bottom shoulder may define a vertical plane comprising said longitudinal axis, wherein the shoulders defining a height higher than a height of said shank.

The drill bit may also include a top proximal head extending distally from the top shoulder, the top proximal head extending higher than the shank height. The top proximal head may extend distally on an elongated body. The elongated body may achieve a maximal height, and narrows distally from the maximal height towards a distal end of the drill bit. The elongated body may extend in parallel with the longitudinal axis and provides a step-wise drop towards the distal end. The step-wise drop may include at least five drops, each of the five drops having a vertical bar and a horizontal shelf. A vertical bar may set a flat section along the distal end or top end. The step-wise drop comprises at least eight drops, each of the eight drops having a vertical bar and a horizontal shelf.

The drill bit may include a gap set along the elongated body, wherein a distance between the shoulder and a vertical bar at the distal end comprises a length, with a midpoint set halfway between the shoulder and the distal end along the longitudinal axis, the gap extending over the midpoint. The distance between the shoulder and a vertical bar at the distal end may include a midpoint set halfway between the shoulder and the distal end along the longitudinal axis with the gap extends proximal the midpoint.

The drill bit may include a vertical distal bar with a height less than a height of the shank, wherein the elongated body extends at an arc from the longitudinal axis. A gap may be set along the elongated body, wherein the gap extends proximal the midpoint with a midpoint set halfway between the shoulder and the distal end along the longitudinal axis. The distance between the shoulder distal end may include a midpoint set halfway between the shoulder and the distal end along the longitudinal axis wherein the gap begins and ends proximal of a maximal height of the elongated bar.

The drill bit may include a bottom proximal head extending distally from a bottom shoulder, the bottom proximal head extending below than a shank lower limit The top shoulder may be set at ninety-degree angle from the neck.

### BRIEF DESCRIPTION OF THE DRAWINGS

The present invention will be described with greater specificity and clarity with reference to the following drawings, in which:

FIG. 1 is a perspective front view of an embodiment of a fastener driving tool in accordance with the invention.

FIG. 2 is a front view of an embodiment of a fastener driving tool of FIG. 1.

FIG. 3 is a rear view of an embodiment of a fastener driving tool of FIG. 1.

FIG. 4 is a right side view of an embodiment of a fastener driving tool of FIG. 1.

FIG. 5 is a left side view of an embodiment of a fastener driving tool of FIG. 1.

FIG. 6 is a top view of an embodiment of a fastener driving tool of FIG. 1.

FIG. 7 is a bottom view of an embodiment of a fastener driving tool of FIG. 1.

FIG. 8 is a perspective front view of an alternative embodiment of a fastener driving tool in accordance with the invention.

FIG. 9 is a front view of an embodiment of a fastener driving tool of FIG. 8.

FIG. 10 is a rear view of an embodiment of a fastener driving tool of FIG. 8.

FIG. 11 is a right side view of an embodiment of a fastener driving tool of FIG. 8.

FIG. 12 is a left side view of an embodiment of a fastener driving tool of FIG. 8.

FIG. 13 is a top view of an embodiment of a fastener driving tool of FIG. 8.

FIG. 14 is a bottom view of an embodiment of a fastener driving tool of FIG. 8.

FIG. 15 is a perspective front view of a further embodiment of a fastener driving tool in accordance with the invention.

FIG. 16 is a front view of an embodiment of a fastener driving tool of FIG. 15.

FIG. 17 is a rear view of an embodiment of a fastener driving tool of FIG. 15.

FIG. 18 is a right side view of an embodiment of a fastener driving tool of FIG. 15.

FIG. 19 is a left side view of an embodiment of a fastener driving tool of FIG. 15.

FIG. 20 is a top view of an embodiment of a fastener driving tool of FIG. 15.

FIG. 21 is a bottom view of an embodiment of a fastener driving tool of FIG. 15.

### DETAILED DESCRIPTION OF THE PREFERRED EMBODIMENTS

The invention relates to a fastener driving tool for driving hooks, eyebolts, and similar threaded fasteners lacking a head feature able to be apprised by conventional driving tools. The inventive fastener driving tool has a loop portion defined by a closed contour having proximal and a distal end. The loop portion defines a longitudinal internal dimension, and is interrupted by a gap at a longitudinal distance from the proximal end. A shank is affixed to the proximal end of the loop, with the shank defining a longitudinal axis of rotation. According to preferable embodiments, the longitudinal distance from the proximal end to the gap is less than one-half the longitudinal internal dimension, and the closed contour of the loop may be selected from a set of contours consisting of: an ellipse, an oval, an ovoid, a trapezoid, a trapezoid having stepped sides, and a rectangle.

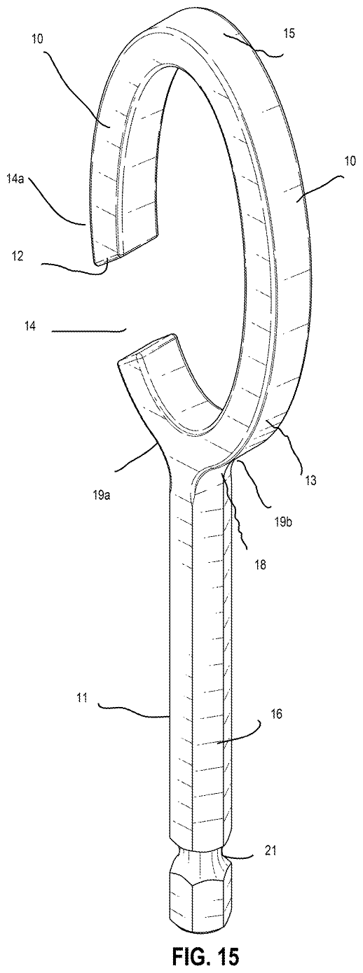

Referring now to the figures, FIG. 15 shows a stylized front view of an embodiment of a fastener driving tool 1a in accordance with the invention which has a contour which is an ellipse. The fastener driving tool comprises a loop portion 10 defined by a closed contour 12 having a proximal end 13 and a distal end 15. The loop portion defines a longitudinal internal dimension L and the loop portion is interrupted by a gap 14 at a longitudinal distance g from the proximal end. The tool further comprises a shank 11 affixed to the proximal end of the loop, with the shank defining a longitudinal axis of rotation 16. The gap cuts into the loop at an angle a with respect to a local portion of the closed contour defining the loop.

The shank may include a recessed collar 5 adapted to complement with a standard rotary drill attachment. The butt end 1 may include a hexagonal shape adapted to complement and conform to the drill end. Embodiments of the present invention include a hollow center 2 that allows the bit to engage a hooked or tie-in end.

In a preferable embodiment, the longitudinal distance from the proximal end to the gap is less than one-half of the longitudinal internal dimension. The half-way point is a midpoint indicated at L/2.

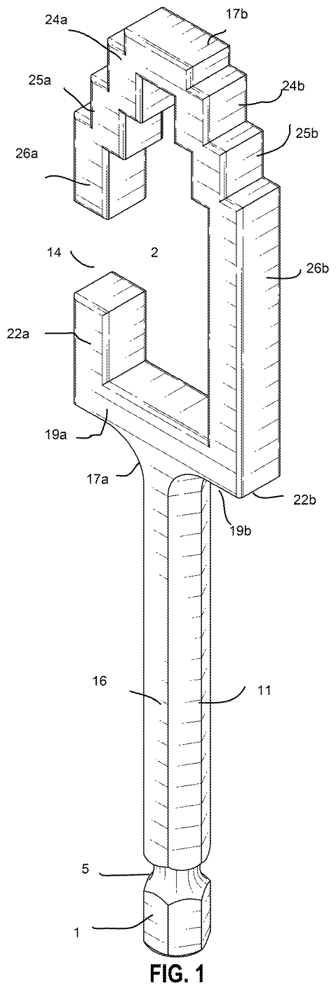

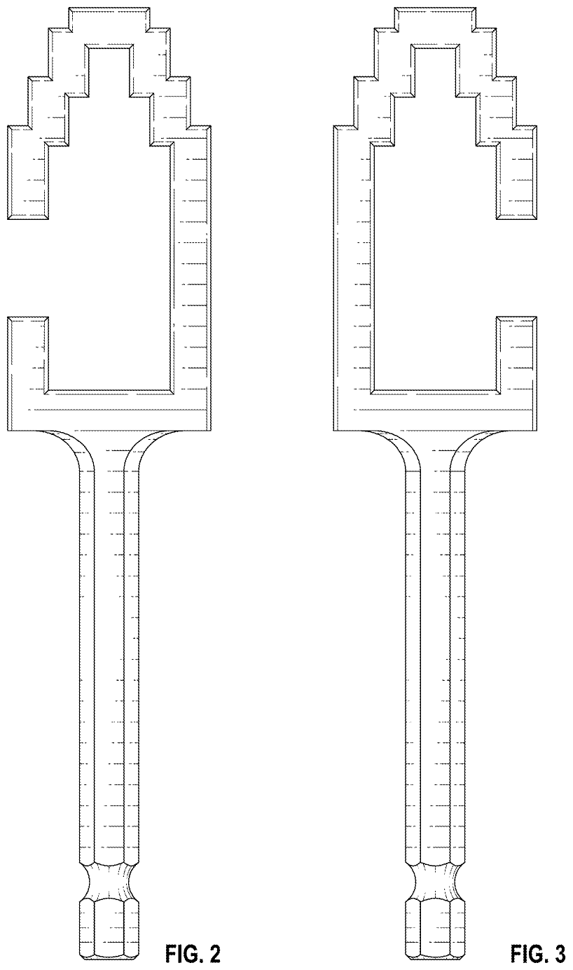

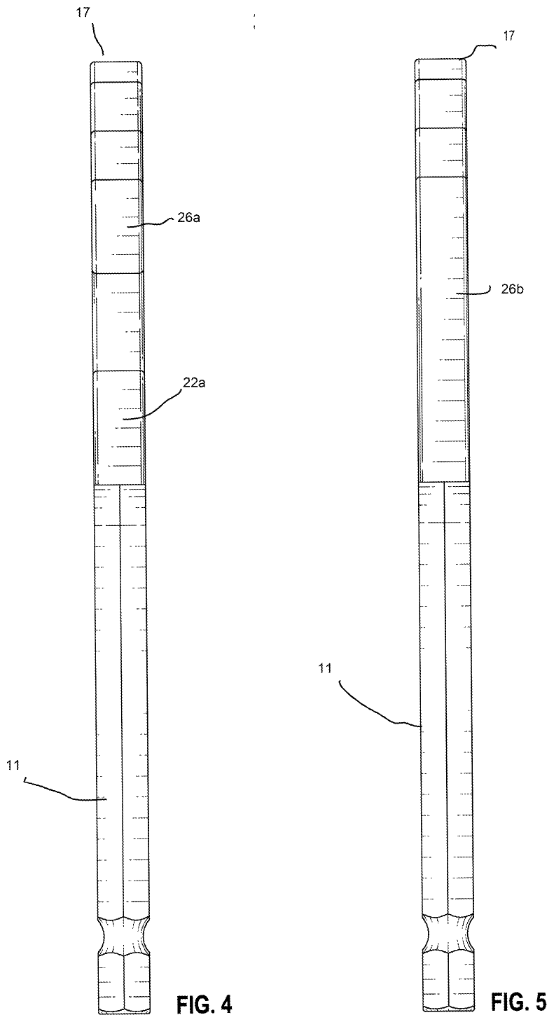

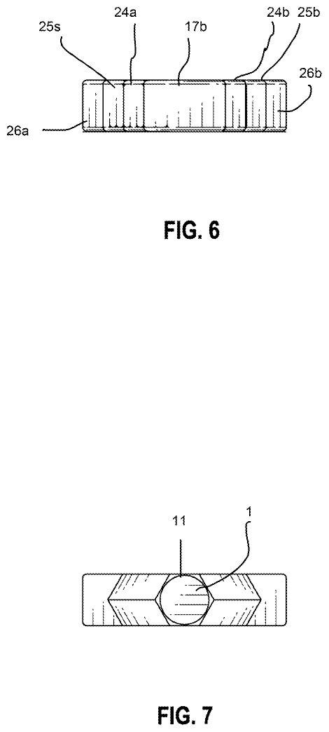

FIG. 1 shows a stylized front view of an alternative embodiment of a fastener driving tool or drill bit 1b in accordance with the invention which has a closed contour 10 which is a rectangle having one vertical bar as a distal end 15, and another vertical bar as a proximal end 13 that proceeds from a shank 11 adapted to attach to a powered drive mechanism such as a drill chuck. The center of the shank defines a longitudinal axis 16 which is also the rotational axis of the drill bit when in use. A gap 14 cuts into a portion of the closed contour 12 at an angle a with respect to the local portion of the closed contour defining the rectangle. The bit may be set into various sized of apertures so as to mate at the cross-sectional width of the particular step of the drill bit.

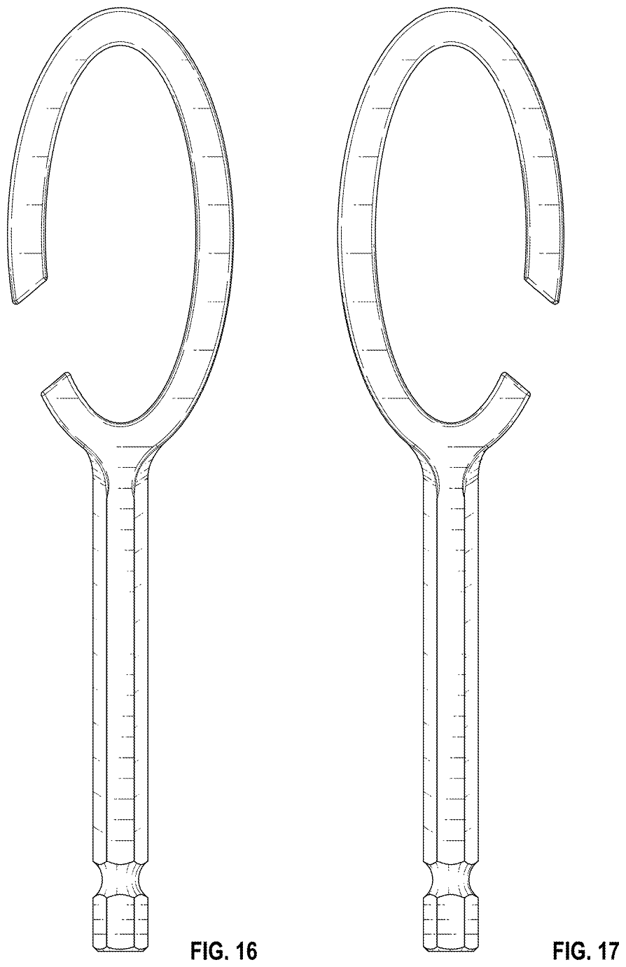

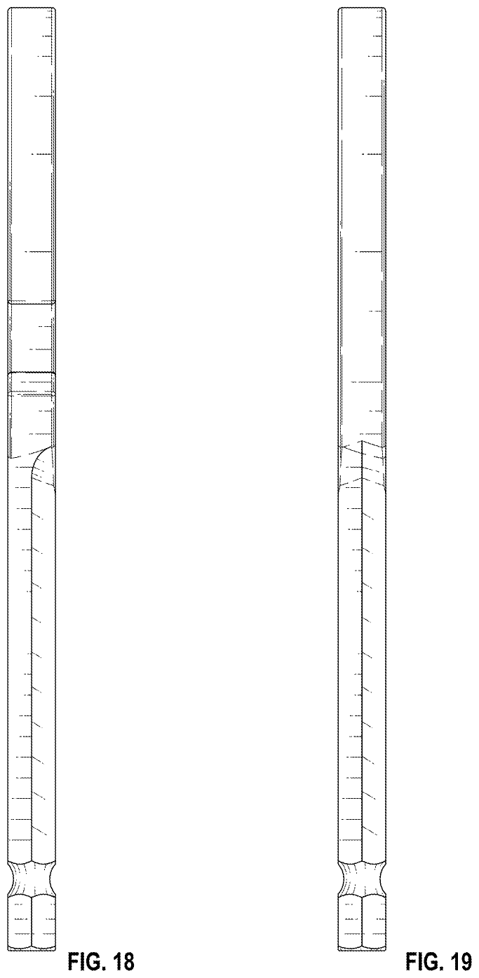

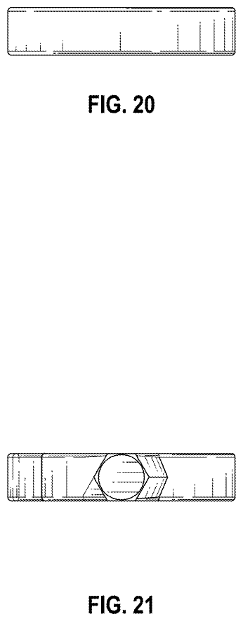

FIG. 16 shows an oblique front bottom right view of the fastener driving tool seen in FIG. 15. In this embodiment shown, the shank 11 has a groove 21 near its proximal end for improved gripping by a drill chuck. A distal end has a loop portion 10 with a loop contour including a gap 14 to admit an eye of an eyebolt. The shank defines a longitudinal axis 16. At the proximal end of the loop the drill bit bifurcates to proceed to a top shoulder 19a and bottom shoulder 19b defining a plane—A—which comprises the longitudinal axis and the elliptical closed contour of the loop. Each of the shoulders continues as an elongated body extending at an arc from the longitudinal axis.

FIG. 16 shows a front view of the fastener driving tool seen in FIG. 15 which is an embodiment of a drill bit where the shank 11 includes or proceed to a neck 18 extending distally from the shank. A top shoulder 19a depends from the neck, and this shoulder comprises an upper deviation from the longitudinal axis 16 at an angle al which is greater than zero. A bottom shoulder 19b also depends from the neck, with this shoulder comprising a lower deviation from the longitudinal axis at an angle a2 which is also greater than zero.

In this embodiment the shoulders proceed to form a loop contour which is an ellipse that increases in height above and below the thickness of the shank to a maximal height area at the minor diameter of the loop, and then narrows distally from that maximal height towards a distal end of the drill bit. The major diameter of the ellipse is defined from the neck of this embodiment to the distal end of the drill bit. The distance between the origin of the shoulders and the distal end comprises a length L, with a midpoint set halfway (L/2) between the shoulders and the distal end along the longitudinal axis.

A gap 14 is set along the elongated body and extends proximal of the midpoint. In a preferable embodiment the gap begins and ends proximal of the maximal height of the elongated bar. Where the closed contour of the loop is an ellipse, the maximal height occurs at the midpoint. Other ovoid contours also reside within the scope of the invention and these may have a maximal height at a point other than the mid-length of the contour. Also, the gap may be set wide enough to reside distal to the midpoint of the contour as an alternative embodiment having its material end at the distal end of the gap begin as shown by phantom line 14a.

FIG. 1 shows a front view of an alternative embodiment of a fastener driving tool in accordance with the invention which has a contour that includes portions having stepped series of pairs of parallel sections. This embodiment includes a shank section which defines a longitudinal axis 16. A coordinate system in this figure defines a proximal direction P, a distal direction D, and a vertical direction V perpendicular to and orthogonal to the P and D directions. This coordinate system is also applicable for other front view figures.

The shank has an upper height h1 at its outer diameter or width. The shank proceeds to a neck section which bifurcates to define a proximal vertical bar having a first transverse axis 17a. The distal end of the drill bit includes a distal vertical bar extending along and defining a second transverse axis 17b. The upper portion of the proximal bar proceeds to a top shoulder 19a from which a top proximal head 22a extends distally and longitudinally as an elongated body which achieves a maximal height h2 greater than the shank height h1. The opposite or lower surface of the shank defines a depth d1 below the longitudinal axis of the shank.

In this embodiment, the maximal height is maintained by material continuing longitudinally across a gap 14, but in other alternatives within the scope of the invention the continuation section may have a maximum height greater or less than the height of the top proximal head. The drill bit defines a distance L between the proximal shoulder and the vertical bar at the distal end, with a midpoint set L/2 halfway between the proximal shoulder and the distal end along the longitudinal axis. In the embodiment shown the gap extends over this midpoint. A phantom line residing in the continuation of material of the upper portion of the contour shows an alternative embodiment within the scope of the invention wherein the gap extends proximal to the midpoint and ends proximal to the midpoint. The continuation of material resumed from across the gap comprises an additional series of elongated bodies 26a, 26b, 26c with each longitudinal extension narrowing distally from the maximal height towards the distal end of the drill bit.

The lower portion of the proximal bar proceeds to a bottom shoulder 19b from which a bottom proximal head 22b extends distally and longitudinally as an elongated body which achieves a maximal depth d2 further beneath the shank depth d1, so that the absolute value of d2 is greater than d1. The lower longitudinal extension of material comprises a series of abutted blocks 24b, 25b, 26c comprising a stepped series of rises in height of material along a lower portion of a closed contour of a drill bit. These abutted blocks are preferably symmetrical to the series of blocks of the upper portion of the drill bit, so that aligned pairs of blocks or stepped sections define mutually inward-facing pairs of step surfaces 23a, 23b, 23c, etc.

FIG. 7 shows an oblique front bottom right view of the fastener driving tool seen in FIG. 1. The drill bit comprises a gap set along one of its two elongated bodies which extend from a proximal neck and shoulder section to symmetrical series of abutted stepped blocks, each vertically offset from the next in the series.

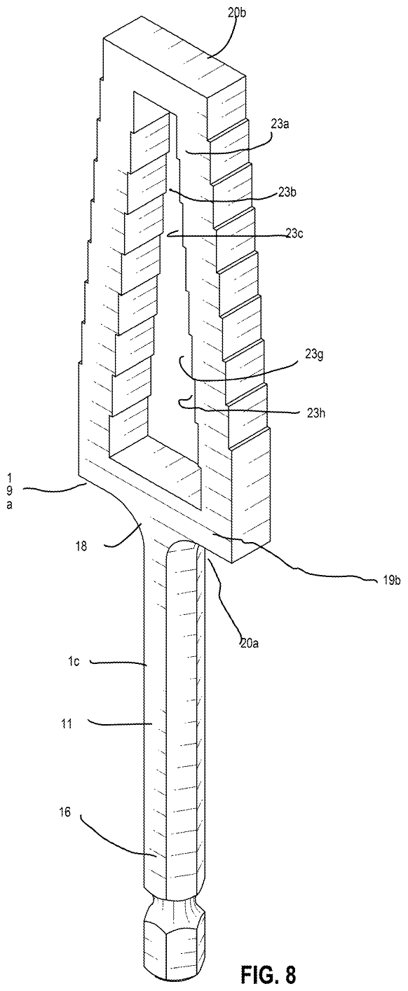

FIG. 8 shows a front view of another alternative embodiment of a fastener driving tool or drill bit 1c in accordance with the invention which has a contour which is a stepped trapezoid with a vertical bar 20b at its distal end. A proximal end comprises a proximal vertical bar 20a and a shank 11 adapted to attach to a powered drive mechanism, with the center of the shank defining a longitudinal axis 16 extending between the proximal and distal ends.

The drill bit shank extends distally from the shank to a neck 18 which proceeds to the vertical bar at the proximal end of the bit. The vertical bar extends above and below the shank. A top shoulder 19a depends from the neck at an upper end of the proximal vertical bar, and a bottom shoulder 19b depends from the neck at a lower end of the proximal vertical bar.

It is also seen that in this embodiment the drill bit top shoulder 19a is set at a ninety-degree angle from the neck, and similarly the bottom shoulder 19b is also set at a ninety-degree angle from the neck. Upper and lower series of elongated bodies extend from these top and bottom shoulders. Each elongated body within each series extends parallel to the longitudinal axis and provides a step-wise drop or narrowing of an internal clearance or width proceeding towards the distal end of the bit, which is also a vertical bar.

According to certain preferable embodiments these step-wise drops or narrowings may comprise at least five drops, or may comprise at least seven drops, or even more such drops, with these drops each comprising a vertical bar and a horizontal shelf. The steps or drops comprise a first series of inward-facing, narrowing, longitudinally spaced apart shelves, and a second series of outwardly-facing longitudinally spaced apart shelves. The mutually inward-facing steps and drops 23a, 23b, 23c, . . . 23g, 23h, etc. are preferably aligned with each other in their longitudinal spacings, however this is not a necessary constraint.

Similarly, the inward-facing steps and outward-facing steps may be longitudinally aligned or, as in this embodiment shown, they may include a longitudinal offset f. Alternative embodiments also within the scope of the invention do not have the same number of inward-facing steps as outward-facing steps. The drill bit is preferably symmetrical across the rotational axis of the shank, but this also is not a necessary constraint.

FIG. 8 shows an enlargement of a stepped trapezoid section of an embodiment of a fastener driving tool or drill bit in accordance with the invention. According to some embodiments within the scope of the invention, drops within a series of abutted blocks comprise a vertical bar and a horizontal shelf. In this figure, a first longitudinally elongated block 26a defines a horizontal shelf 23c and a second, adjacent longitudinally elongated block 25a defines another horizontal shelf 23b. Each elongated block has its own centerline 27. The adjacent blocks are joined by a vertical bar 28 of a width w and having its own vertical centerline 29. In this embodiment the vertical bar is discrete and visibly distinct between the two longitudinally elongated blocks.

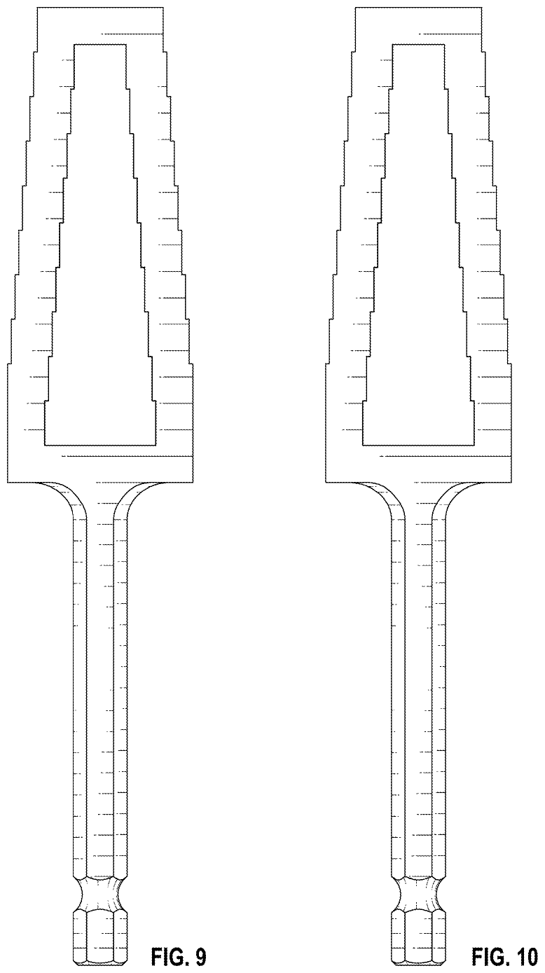

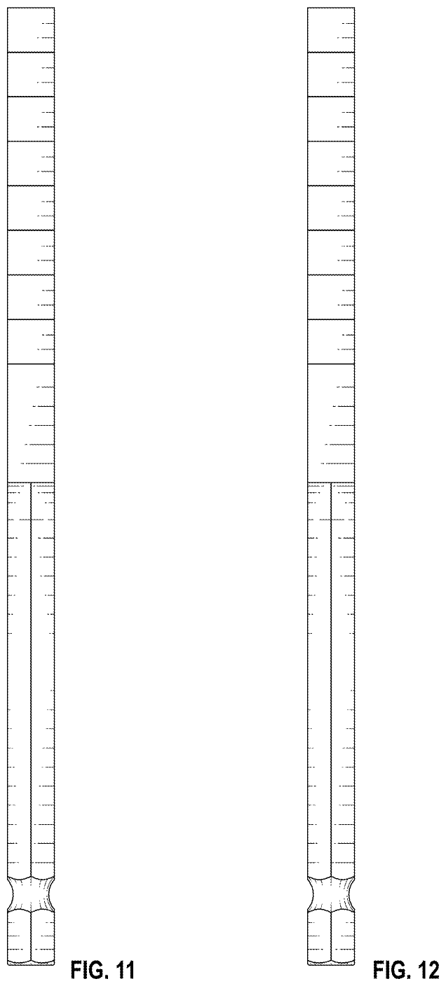

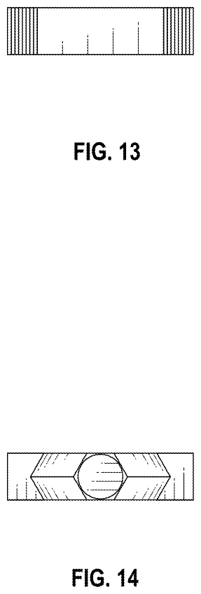

FIG. 9-10 show an enlargement of an alternative embodiment of a stepped trapezoid section of a fastener driving tool or drill bit in accordance with the invention. Each of the blocks 24a, 25a, 26a within the drop series comprises a vertical bar and a horizontal shelf, however in this example the blocks are so closely abutted that the vertical bar is not easily visually discernable in that it resides within the abutted section of the blocks where a vertical centerline 29 connects the end of one longitudinal centerline 27 and the beginning of the next.

In an exemplary embodiment of a series of five abutted and offset blocks, each of the five drops comprise a vertical bar and a horizontal shelf. For the first or the last block in the series, the vertical bar may be the proximal or the distal vertical bar at the beginning or end of the series.

FIG. 8 shows a front view of another alternative embodiment of a fastener driving tool similar to that of FIG. 1, but with an especially narrow distal vertical section wherein the vertical distal bar 20b has a height h3 as measured from the shank centerline 16 which is less than a height h1 of the outer surface of the shank. This end protuberance may optionally be chiseled or sharpened or fluted to act as a pilot bit which may be used to drill a pilot hole for initially receiving lag threads of a threaded fastener engaged by inner surfaces of the other stepped features of the drill bit.

I claim:

1. A drill bit with a proximal end comprising a shank adapted to attach to a powered drive mechanism, and a distal end, a center of the shank defining a longitudinal axis as between said proximal and distal ends, said drill bit comprising:
a. a neck extending distally from said shank;
b. a top shoulder depending from said neck, said top shoulder comprising an upper deviation from said longitudinal axis at an angle greater than zero;
c. a bottom shoulder depending from said neck, said bottom shoulder comprising a lower deviation from said longitudinal axis at an angle greater than zero, said top shoulder and bottom shoulder defining a vertical plane comprising said longitudinal axis, and said shoulders defining a height higher than a height of said shank.

2. The drill bit as defined in claim 1, further comprising a top proximal head extending distally from said top shoulder, said top proximal head extending higher than said shank height.

3. The drill bit as defined in claim 2, wherein said top proximal head extends distally to an elongated body.

4. The drill bit as defined in claim 3, wherein said elongated body achieves a maximal height and narrows distally from said maximal height towards a distal end of said drill bit.

5. The drill bit as defined in claim 4, wherein said elongated body extends in parallel with said longitudinal axis and provides a step-wise drop towards said distal end.

6. The drill bit as defined in claim 5, wherein said step-wise drop comprises at least five drops, each of said five drops comprising a vertical bar and a horizontal shelf.

7. The drill bit as defined in claim 6, further comprising a vertical bar along said distal end.

8. The drill bit as defined in claim 5, wherein said step-wise drop comprises at least eight drops, each of said eight drops each comprising a vertical bar and a horizontal shelf.

9. The drill bit as defined in claim 8, further comprising a vertical bar along said distal end.

10. The drill bit as defined in claim 5, comprising a gap set along said elongated body.

11. The drill bit as defined in claim 10, wherein a distance between said shoulder and a vertical bar at said distal end comprises a length, with a midpoint set halfway between said shoulder and said distal end along said longitudinal axis, and said gap extends over said midpoint.

12. The drill bit as defined in claim 10, wherein a distance between said shoulder and a vertical bar at said distal end comprises a length, with a midpoint set halfway between said shoulder and said distal end along said longitudinal axis, and said gap extends proximal said midpoint.

13. The drill bit as defined in claim 1, further comprising a vertical distal bar with a height less than a height of said shank.

14. The drill bit as defined in claim 4, wherein said elongated body extends at an arc from said longitudinal axis.

15. The drill bit as defined in claim 14, wherein a distance between said shoulder and said distal end comprises a length, with a midpoint set halfway between said shoulder and said distal end along said longitudinal axis, a gap set along said elongated body, wherein said gap extends proximal said midpoint.

16. The drill bit as defined in claim 14, wherein a distance between said shoulder said distal end comprises a length, with a midpoint set halfway between said shoulder and said distal end along said longitudinal axis, a gap set along said elongated body, wherein said gap begins and ends proximal of a maximal height of said elongated bar.

17. The drill bit as defined in claim 1, further comprising a bottom proximal head extending distally from a bottom shoulder, said bottom proximal head extending below than a shank lower limit

18. The drill bit as defined in claim 1, wherein said top shoulder is set at ninety-degree angle from said neck.
